(19) United States
(12) Patent Application Publication
(10) Pub. No.: US 2011/0038703 A1
(43) Pub. Date: Feb. 17, 2011

(54) Fill-a box

(76) Inventors: Durand Kevin Dickerson, (US); Lawernce D Kenemore, (US)

Correspondence Address: Durand Kevin Dickerson, 1514 10th Avenue, Leavenworth, KS, 66048, US

(21) Appl. No.: 12/658,460

(22) Filed: Feb. 10, 2010

Related U.S. Application Data
(60) Provisional application No. 61/207,477, filed on Feb. 12, 2009.

(51) Int. Cl. B65G 67/04; B65D 85/00

(52) U.S. Cl. 414/800; 206/459.5

(57) ABSTRACT

The invention Fill-A-Box is a specific process that through it's execution, keeps (HHW)(HW) from reaching the landfill. The Fill-A-Box process establishes a new standard in collecting, sorting, weighing, and categorizing data from the individuals households or residences. The collecting element of Fill-A-Box provides for the pick-up of: Plastics, Glass, Paper, Unused/Unneeded Pharmaceuticals, Cardboard, Aluminum, Batteries, and Electronic waste. Fill-A-Box has a compartmentalized design, allowing for user friendly placement of products. Upon curbside pick-up of Fill-A-Box, it is scanned and weighed. Once reaching the operations center, each compartment is counted then weighed. Finally all the data that has been established is sent into a database.

### SUMMARY OF THE INVENTION

The object of this invention is to know by address/location the exact amount, weight, and count of (HHW) (HW) that is being recycled. The Fill-A-Box as in Drawings 1 and 2 was designed for placement in the household's kitchen next to the current trash can location, and or canteens or other business locations. The design, Drawings 1 and 2 along with the printing in evergreen color promotes a daily reminder of recycling and the specific (HHW) (HW) that needs to be recycled. That is the size of Drawings 1 and 2 and the color of printing on the Fill-A-Box motivates the recycling of (HHW) (HW) on a daily basis.

The Fill-A-Box invention Drawings 1 and 2 and methods 1 through 18 produce a verifiable figure by address/location of the success of (HHW) (HW) recycling.

The Fill-A-Box invention Drawings 1 and 2 along with the claims 1 through 18 produces a factual number by address/location of (HHW) (HW) that makes a report by City, County, State of the actual amount of (HHW) (HW) removed from the landfills and water systems.

### BRIEF DESCRIPTION OF THE DRAWINGS

This invention will now be examined in greater detail by way of reference to the accompanying drawings 1 and 2 wherein:

1 of 2 shows a box with the cuts and sizes of the cuts of the cardboard which will be 3/16″ thick cardboard including all four (4) sides of the box.

2 of 2 shows the three (3) cardboard pieces that are used to separate the compartments inside the box and it is placed inside the box after Drawing 1 of 2 is assembled. This creates four (4) compartments inside the box.

Drawing 3 shows by alphabet the placement of the printing on the box which refers to Drawing 4 for the exact wording of the printing.

The print is in the color or evergreen.

### DESCRIPTION OF PREFERRED EMBODIMENTS

Drawing 1 of 2 designates a box Fill-A-Box having four (4) inside compartments and one (1) outside compartment for recyclable (HHW) (HW). These compartments are designated for specific (HHW) (HW) materials and the size of the compartments and the hole for receiving (HHW) (HW) is designated on drawing 1. Looking at Drawing 1 of 2 on the left side shows compartment-D which is designated for plastics as outlined in drawing 4 and the receiving hole size is set at 4″×4″. Compartment-J is designated for aluminum products as outlined in Drawing 1 of 2 the receiving hole size is 4″×4″. Drawing 1 of 2 shows compartment K which is designated for electronics and the receiving hole is 10″×6″. Compartment E is designated as a fold down cardboard that creates a slot for glass and unused and unneeded pharmaceuticals and light bulbs including fluorescent bulbs. This need not be folded down unless those products are to be placed in that compartment. Compartment-H is designated for newspapers, books, magazines, shredded paper is 13 3/16″×14″×4″ which is the top portion of the Fill-A-Box standing open. #M is the back portion of the box that does not contain any holes or compartments except as shown is a punch out for a carrying handle. The box when fully assembled stands 26″ high is 14″ square. The inside divider of the box Drawing 2 of 2 shows the 11″×3/16″ cut for the two pieces fitting inside those slots to create an X divider. The 24½″×/22″ single piece divider is creased for folding at 8″ from each end creating a flat fold against the inside of the box against the corner creating 8½ slot for the glass light bulbs, fluorescent bulb, and unused unneeded pharmaceuticals. Page-5 gives the different views of the assembled Fill-A-Box with the printing on the box. Drawings 1 through 6 are intended to form a complete view of the completed and assembled Fill-A-Box.

I claim:

1. A method of collection, sorting, recycling, Household Hazardous Waste (HHW) and Hazardous Waste (HW) by way of the box which is Drawings 1 and 2, with specific printing as shown in Drawings 3 and 4. This box (Fill-A-Box) is placed in address/locations for the collection of (HHW) and (HW) and for return to the Fill-A-Box plant by curbside pick-up which is achieved by the pick-up at curbside being done by Fill-A-Box employees that will first scan the barcode on the box that was placed there prior to delivery to the address/location into a PDA or Wi-Fi device that activates the database program at the plant. The Fill-A-Box is then weighed on the spot curbside and the total weight is registered in the database program at the plant. Upon arrival at the plant the Fill-A-Box is then again weighed and compared to the pick-up weight. The Fill-A-Box is then disassembled by compartment in the plant and each compartments contents are weighed by as outlined in claim-2 and the data entered into the database program by barcode/address/location.

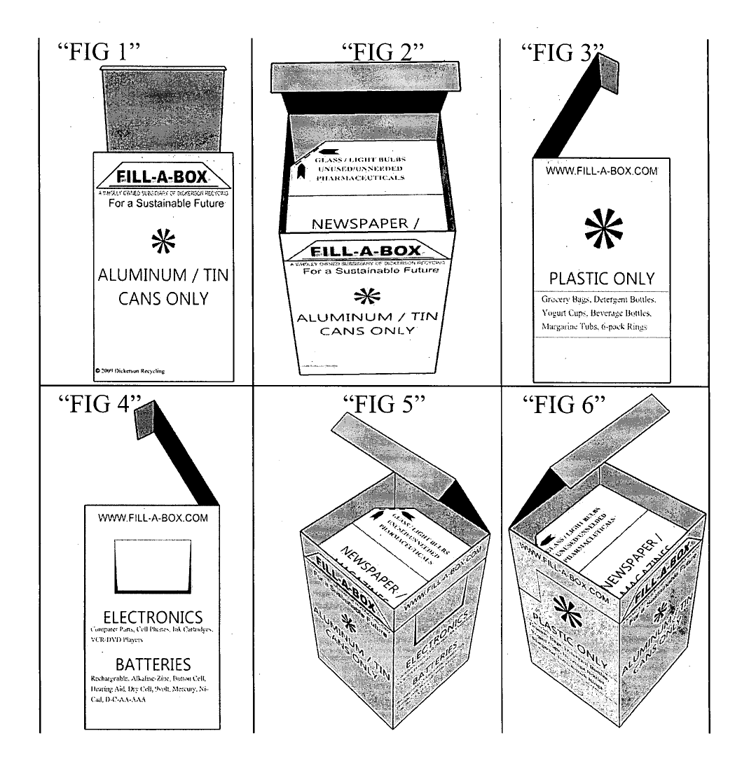

2. The Fill-A-Box Drawings 1 and 2 are designed to be manufactured of cardboard 3/16″ that is recyclable, see Drawings 1 and 2. The Fill-A-Box is put together with Drawing 2 being the separator used to separate the compartment within the inside of the Fill-A-Box. These compartments are:
A. PLASTICS-grocery bags, detergent bottles, yogurt cups, beverage bottles, margarine tubs, 6-pack rings, miscellaneous plastic
B. GLASS-light bulbs, fluorescent bulbs, jars, miscellaneous bottle
C. PAPER-newspapers, shredded paper, books, magazines
D. UNUSED, UNNEEDED PHARMACEUTICALS
E. CARDBOARD-All types including beer cartons
F. ALUMINUM-Cans, wrappers, bags, foil, miscellaneous aluminum
G. AUTOMOBILE BATTERIES
H. BATTERIES-rechargeable, alkaline/zinc, button cell, hearing aid, dry cell, 9-volt, mercury, D-C-AA-AAA, ni-cad, miscellaneous batteries
I. ELECTRONICS-computers, cell-phones, printers, printer-ink cartridges DVD players, VCR players, miscellaneous electronics
The Fill-A-Box is screen printed on the outside pursuant to Drawings 3 and 4 in evergreen ink color, the bottom of the box was sealed upon delivery to the address/location with non-removable tape, and the top lid FIG. 1 has attached to it for sealing a non-removable tape strip that is sealed prior to curbside placement. The disassembly and weight at the plant includes the total weight and also the count of items that include, such as: Coca Cola original size aluminum cans, plastic bottles and or 7-up bottles, detergent bottles. Manufacture product name and size, margarine tubs manufacture and size, yogurt cups manufacture and size, batteries by size in claim-1 and manufacture, electronics such as cell-phones manufacture name, printers manufacture name, DVD players manufacture, VCR players manufacture name, computers manufacture name, printer ink-cartridge manufacture name. All this data is collected in a database program by bar code/address/location.

3. A method claimed in 1 and 2, in which a database program is used by bar code/address/location that identifies:
A. address/location of the Fill-A-Box in Drawings 1 and 2
B. total weight collected by address/location by date
C. weight and count of items listed in (2) A through I by product name and manufacture and size such as Coca Cola original 12 ounce by total for year to date.

4. A method claimed in 1 and 2, in which a database program is used by barcode/address/location that identifies:
A. # of fluorescent bulbs and weight by size and manufacture by total for year to date

5. A method as claimed in 1 and 2 in which a database program is used by barcode/address/location that identifies:
A. weight of newspapers, shredded paper, magazines, books, by total for year to date

6. A method claimed in 1 and 2, in which a database program is used by barcode/address/location that identifies:
A. weight of unused/unneeded pharmaceuticals by total for year to date

7. A method as claimed in 1 and 2, in which a database program is used by barcode/address/location which identifies:
A. weight of cardboard by total for year to date

8. A method claimed in 1 and 2, in which a database program is used by barcode/ address/location which identifies:
A. total number by manufacture of automobile batteries by total for year to date

9. A method as claimed in 1 and 2, in which a database program is used by barcode/address/location that identifies:
A. batteries by manufacture, size and total weight by total for year to date

10. A method as claimed in 1 and 2, in which a database program is used by barcode/address/location that identifies:
A. computer parts by: CPU manufacture total count
Keyboard manufacture total count
Printer manufacture total count
Monitor manufacture total count
Mouse manufacture total count
by total for year to date

11. A method claimed in 1 and 2 in which a database program is used barcode/address/location that identifies:
A. Detergent bottle manufacture and size
B. Margarine tubs manufacture and size
C. Yogurt cups manufacture and size
by total for year to date

12. A method as claimed in 1 and 2 in which a database program is used by barcode/address/location that identifies:
A. aluminum beverage cans by manufacture name and size
by total for year to date

13. A method as claimed in 1 and 2 in which a database program is used by barcode/address/location that identifies:
A. miscellaneous aluminum
by total for year to date

14. A method as claimed in 1 and 2 in which a database program is used by barcode/address/location that identifies:
A. plastic beverage bottles by manufacture name, size,
by total for year to date

15. A method as claimed in 1 and 2 in which a database program is used by barcode/address/location that identifies:
A. total weight of plastic grocery bags
by total for year to date

16. A method as claimed in 1 and 2 in which a database program is used by barcode/address/location that identifies:
A. total weight of miscellaneous plastic
by total for year to date

17. A method as claimed in 1 and 2 in which a database program is used by barcode/address/location that identifies:
A. number and size of light bulbs
by total for year to date

18. A method as claimed in 1 and 2 in which a database program is used by barcode/address/location that identifies:
A. total weight of glass
by total for year to date

19. A method as claimed in 1 and 2 in which a database program is used by barcode/address/location that identifies:
A. cell phones by manufacturer
by total for year to date

20. A method as claimed in 1 and 2 in which a database program is used by barcode/address/location that identifies:
A. manufacture name and model number of printer ink cartridges
by total for year to date.

21. A method as claimed in 1 and 2 in which a database program is used by barcode/address/location that identifies:
A. day to day-week to week-month to month-year to year totals of methods 1 through 17 as to each bar code/address/location

22. The present invention of Fill-A-Box relates to the process, method collection, sorting, weighing, and classifying (HHW) and (HW) by bar code/address/location that quantifies by count, weight, manufacturer of the (HHW)(HW) collected for recycling.
